(19) United States
(12) Patent Application Publication
(10) Pub. No.: US 2017/0249290 A1
(43) Pub. Date: Aug. 31, 2017

(54) METHOD AND SYSTEM FOR PROCESSING A DOCUMENT IN A DISTRIBUTED ARCHITECTURE

(71) Applicant: YANDEX EUROPE AG, Luzern (CH)

(72) Inventor: Denis Valerievich MAKSIMOV, Bolshevo district, Korolev Moscow region (RU)

(21) Appl. No.: 15/511,737

(22) PCT Filed: Oct. 13, 2015
(86) PCT No.: PCT/IB15/57826

§ 371 Date: Mar. 16, 2017

(30) Foreign Application Priority Data
Jun. 29, 2015 (RU) 2015125382

(51) Int. Cl. G06F 17/22; G06F 3/14; G06F 17/24; H04L 29/08

(52) U.S. Cl. CPC G06F 17/2288; H04L 67/1095; G06F 3/1454; G06F 17/24

(57) ABSTRACT

A computer-implemented method (400, 500, 600) and a system (210) for processing a document in a distributed architecture (200). The method comprising accessing the document (310), the document (310) comprising a content portion and a set of revision records, the document (310) being accessible from a plurality of electronic devices including a first electronic device (232) and a second electronic device (234); maintaining a synchronization document (312) comprising at least a portion of the set of revision records of the document; upon receiving a synchronization request: (i) accessing the synchronization document (312); (ii) transmitting the synchronization document (312) to the first electronic device (232); upon receiving an indication that a synchronization on the first electronic device (232) based on the synchronisation document (312) has failed: (i) accessing the document (310); and (ii) transmitting the document (310) to the first electronic device (232).

### CROSS-REFERENCE

The present application claims priority to Russian Patent Application No 2015125382, filed Jun. 29, 2015, entitled “METHOD AND SYSTEM FOR PROCESSING A DOCUMENT IN A DISTRIBUTED ARCHITECTURE” the entirety of which is incorporated herein.

### FIELD

The present technology relates to systems and methods for processing a document in a distributed architecture. In particular, the systems and methods aim at synchronizing changes made to a document in a collaborative context.

### BACKGROUND

The field of collaborative editing, in particular real-time collaborative editing of various types of documents has known a fast development over the last few years. Systems and methods such as the ones implementing Google Docs™, Google Sheets™ and Google Slides™ all from Google Inc. of 1600 Amphitheatre Parkway Mountain View, Calif. 94043, United States of America, allow users to create and edit documents online while collaborating with other users in real-time. The created documents are typically saved automatically on servers and revision history may also be automatically stored so that past edits may be viewed and/or reintroduced in the documents.

Once created, the documents can be shared, opened and edited by multiple users simultaneously and users may be able to see character-by-character changes as other collaborators make edits. The documents may comprise various formats and/or file types such as a word processing program (e.g., “.doc” or “.docx” compatible with Microsoft Word™), a spreadsheet processing program (e.g., “.xls” or “.xlsx” compatible with Microsoft Excel™) and/or a presentation processing program (e.g., “.ppt” or “.pptx” compatible with Microsoft PowerPoint™).

Multiple approaches, including the one detailed in U.S. Pat. No. 8,656,290 (the '290 patent hereinafter), have been developed to allow synchronization of a document shared, opened and edited by multiple users simultaneously. As exemplified in the '290 patent, a server may be configured to receive an edit from a client to create a new version of the document to reflect the received edit. The server may also be configured to determine an update for other clients also sharing the same document and provide the update to the other clients.

### SUMMARY

Embodiments of the present technology have been developed based on developers' appreciation of at least one shortcoming associated with the prior art.

Even though method and systems for synchronizing a document amongst multiple users have been developed, improvements may still be desirable, in particular improvements aiming at reducing an amount of data to be transmitted between a server hosting the shared document and multiple electronic devices associated with multiple users. Such improvements may become even more desirable when the document reaches a certain size.

The present technology arises from an observation made by the inventor(s) that a server may store a document comprising a content portion and a set of revision records in a first database and a synchronization document comprising at least a portion of the set of revision records in a second database. Upon receiving a synchronization request from an electronic device associated with a user, the server may, instead of transmitting the document, only transmit the synchronization document. Providing that the electronic device has already a previous version of the document stored in a memory, the electronic device may then reconstitute the latest version of the document without requiring a transmission of the document (i.e., the document in its entirety) to occur between the server and the electronic device. The present technology therefore allows to (i) reduce an amount of data to be transmitted between the server and the electronic device; and (ii) improve a user experience by reducing an amount of time required for the electronic device to present the document to the user.

Thus, in one aspect, various implementations of the present technology provide computer-implemented method of processing a document in a distributed architecture, the method, for execution by a processor, comprising:
accessing, from a first non-transitory computer-readable medium of a first server, the document, the document comprising a content portion and a set of revision records, the document being accessible from a plurality of electronic devices, the plurality of electronic devices including a first electronic device and a second electronic device;
maintaining, in a second non-transitory computer-readable medium of a second server, a synchronization document, the synchronization document comprising at least a portion of the set of revision records of the document;
upon receiving a synchronization request from the first electronic device:
(i) accessing the synchronization document from the second non-transitory computer-readable medium;
(ii) transmitting the synchronization document to the first electronic device;
upon receiving an indication that a synchronization on the first electronic device based on the synchronisation document has failed:
(i) accessing the document from the first non-transitory computer-readable medium; and
(ii) transmitting the document to the first electronic device.

In some implementations, the method further comprises, upon receiving a first new revision record from the first electronic device:
(i) adding the first new revision record to the document stored in the first non-transitory computer-readable medium; and
(ii) adding the first new revision record to the synchronization document stored in the second non-transitory computer-readable medium.

In some further implementations, the method further comprises, upon receiving a first new revision record from the first electronic device:
(i) adding the first new revision record to the document stored in the first non-transitory computer-readable medium; and
(ii) adding the first new revision record to the synchronization document stored in the second non-transitory computer-readable medium.

In some implementations, upon receiving a first new revision record associated with a first version of the document from the first electronic device and a second new revision record associated with the first version of the document from the second electronic device:
(i) accessing at least one of the document from the first non-transitory computer-readable medium and the synchronization document from the second non-transitory computer-readable medium; and
(ii) generating a new merged revision record based on at least one of the first new revision record, the second new revision record, the document and the synchronization document.

In some implementations, the method further comprises:
(i) adding the new merged revision record to the document stored in the first non-transitory computer-readable medium; and
(ii) adding the new merged revision record to the synchronization document stored in the second non-transitory computer-readable medium.

In some further implementations, the content portion is a first set of revision records and the set of revision records is a second set of revision records.

In some implementations, the first set of revision records and the second set of revision records are indicative of at least one of characters to be added and characters to be removed as a result of an interaction of a user with one of the first electronic device and the second electronic device.

In some further implementations, at least one of the content portion and the set of revision records have a log-like structure.

In some implementations, maintaining, in the second non-transitory computer-readable medium of the second server, the synchronization document comprises, upon determining that the document exceeds a threshold, creating in the second non-transitory computer-readable medium of the second server, the synchronization document based on at least one of the content portion and the set of revision records of the document.

In some further implementations, determining that the document exceeds a threshold comprises at least one of determining that the document exceeds a predetermined number of log entries and determining that the document exceeds a predetermined size expressed in memory unit.

In some implementations, the indication that the synchronization has failed is further to determining, by the first electronic device, that the synchronization document does not allow proper synchronization between a local content stored in a non-transitory computer-readable medium of the first electronic device and the synchronization document.

In some further implementations, determining, by the first electronic device, that the synchronization document does not allow proper synchronization comprises determining that the synchronization document does not contain at least some data required for creating a local version of the document stored in the non-transitory computer-readable medium of the first electronic device, the local version of the document being a mirror image of the document stored in the first non-transitory computer-readable medium of the first server.

In some implementations, the first non-transitory computer-readable medium of the first server is a long-term non-transitory computer-readable medium for long-term storage.

In some further implementations, the second non-transitory computer-readable medium of the second server is a short-term non-transitory computer-readable medium for short-term storage having a faster memory access speed than a memory access speed of the first non-transitory computer-readable medium of the first server.

In some implementations, the synchronization document comprises a rolling subset of past edits made to the document.

In another aspect, various implementations of the present technology provide computer-implemented method of processing a document in a distributed architecture, the method, for execution by a processor, comprising:
accessing, from a first non-transitory computer-readable medium of a first server, the document, the document comprising a content portion and a set of revision records, the document being accessible from a plurality of electronic devices, the plurality of electronic devices including a first electronic device and a second electronic device;
maintaining, in a second non-transitory computer-readable medium of a second server, a synchronization document, the synchronization document comprising at least a portion of the set of revision records of the document;
upon receiving a synchronization request from the first electronic device:
(i) accessing the synchronization document from the second non-transitory computer-readable medium;
(ii) upon determining that the synchronization document allows proper synchronization for the first electronic device, transmitting the synchronization document to the first electronic device;
(iii) upon determining that the synchronization document does not allow proper synchronization for the first electronic device:
   (a) accessing the document from the first non-transitory computer-readable medium; and
   (b) transmitting the document to the first electronic device.

In another aspect, various implementations of the present technology provide computer-implemented method of processing a document in a distributed architecture, the method, for execution by a processor, comprising:
accessing, from a first non-transitory computer-readable medium of a first server, the document, the document comprising a content portion and a set of revision records, the document being accessible from a plurality of electronic devices, the plurality of electronic devices including a first electronic device and a second electronic device;
upon determining that a size of the document exceeds a threshold:
(i) creating, in a second non-transitory computer-readable medium of a second server, a synchronization document, the synchronization document comprising at least a portion of the set of revision records of the document;
upon receiving a synchronization request from the first electronic device:
(i) accessing the synchronization document from the second non-transitory computer-readable medium;
(ii) transmitting the synchronization document to the first electronic device;
upon receiving an indication that a synchronization on the first electronic device based on the synchronisation document has failed:
(i) accessing the document from the first non-transitory computer-readable medium; and
(ii) transmitting the document to the first electronic device.

In other aspects, various implementations of the present technology provide a non-transitory computer-readable medium storing program instructions for processing a document in a distributed architecture, the program instructions being executable by a processor of a computer-based system to carry out one or more of the above-recited methods.

In other aspects, various implementations of the present technology provide a computer-based system, such as, for example, but without being limitative, an electronic device comprising at least one processor and a memory storing program instructions for processing a document in a distributed architecture, the program instructions being executable by one or more processors of the computer-based system to carry out one or more of the above-recited methods.

In the context of the present specification, unless expressly provided otherwise, an “electronic device”, a “server”, “remote server”, and a “computer-based system” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a computer system suitable for implementing the present technology and/or being used in conjunction with implementations of the present technology;

FIG. 2 is a diagram of a networked computing environment in accordance with an embodiment of the present technology;

FIG. 3 is a diagram illustrating a document along with a synchronisation document in accordance with an embodiment of the present technology;

FIG. 4 is a flowchart illustrating a first computer-implemented method implementing embodiments of the present technology;

FIG. 5 is a flowchart illustrating a second computer-implemented method implementing embodiments of the present technology; and

FIG. 6 is a flowchart illustrating a third computer-implemented method implementing embodiments of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

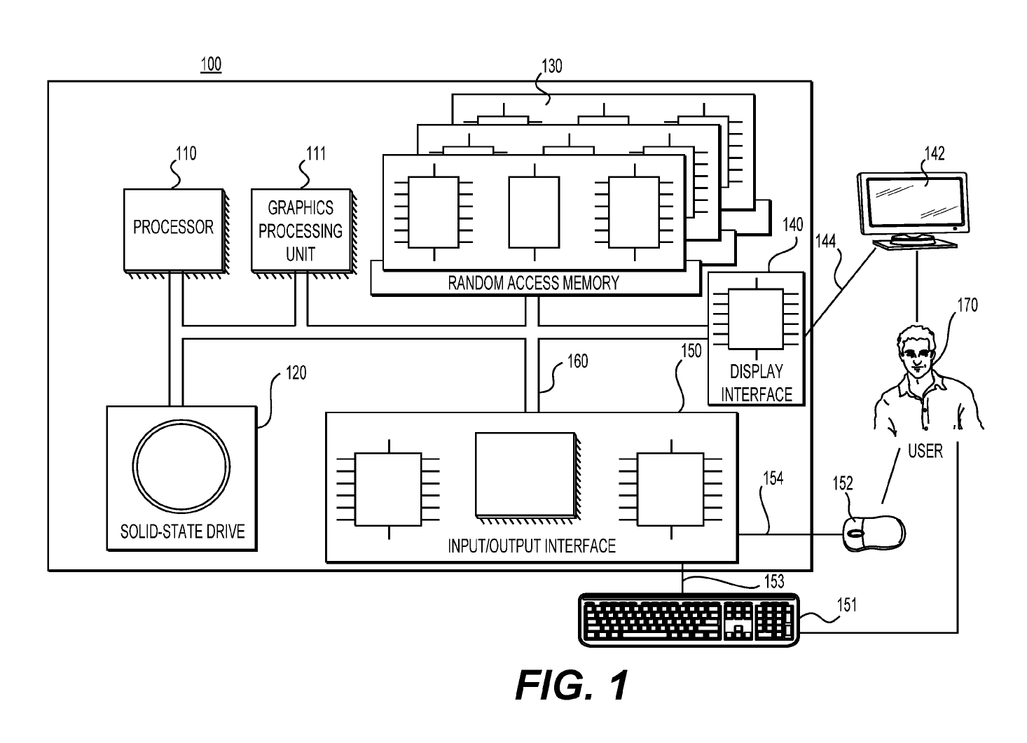

Referring to FIG. 1, there is shown a computer system 100 suitable for use with some implementations of the present technology, the computer system 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled. The display interface 140 may be coupled to a monitor 142 (e.g. via an HDMI cable 144) visible to a user 170, and the input/output interface 150 may be coupled to a touchscreen (not shown), a keyboard 151 (e.g. via a USB cable 153) and a mouse 152 (e.g. via a USB cable 154), each of the keyboard 151 and the mouse 152 being operable by the user 170.

According to implementations of the present technology, the solid-state drive 120 stores program instructions suitable for being loaded into the random access memory 130 and executed by the processor 110 and/or the GPU 111 for generating a heat map. For example, the program instructions may be part of a library or an application.

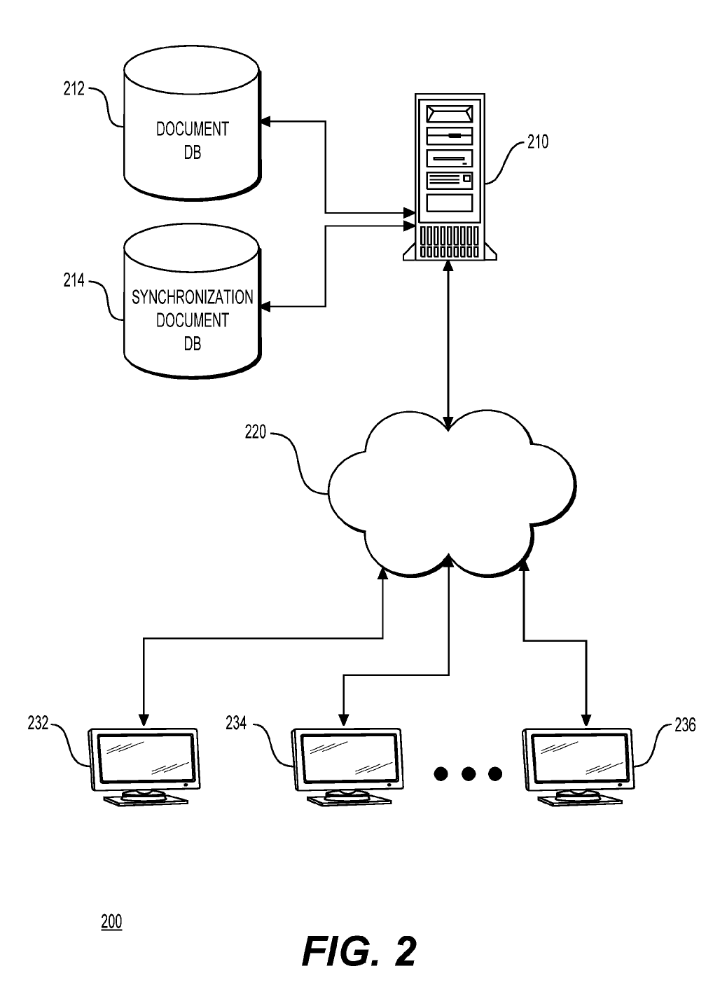

In FIG. 2, there is shown a networked computing environment 200 suitable for use with some implementations of the present technology, the networked computing environment 200 comprising a document server 210 (also referred to as a “remote server” or as a “server”), a document database 212, a synchronization document database 214, electronic devices 232, 234, 236 (also referred to as “client devices”, “electronic devices” or “electronic devices associated with users”) in communication with the document server 210 via a network 220 (e.g., the Internet) enabling these systems to communicate.

The implementation of the electronic devices 232, 234, 236 is not particularly limited, but as an example, the electronic devices 232, 234, 236 may interact with the document server 212 by receiving input from users and receiving and transmitting data via the network 220. In some embodiments, each one of the electronic devices 232, 234, 236 is associated with a specific user. In some other embodiments, each one of the electronic devices 232, 234, 236 is associated with multiple users. In yet some other embodiments, each one of the electronic devices 232, 234, 236 is associated with a same user. The electronic devices 232, 234, 236 may be, for example and without being limitative, a desktop computer, a laptop computer, a smart phone (e.g. an Apple iPhone™ or a Samsung Galaxy S5™), a personal digital assistant (PDA) or any other device including computing functionality and data communication capabilities. In some embodiments, the electronic device 232 may be a first mobile device, the electronic device 234 may be a second mobile device and the electronic device 236 may be a desktop computer. Each one of the electronic devices 232, 234, 236 is associated with a same user that may rely on the present technology to ensure synchronization of one or more shared documents amongst all of the electronic devices 232, 234, 236. The electronic devices 232, 234, 236 may comprise internal hardware components including one or more single or multi-core processors collectively referred to herein as processor 110, a GPU 111, a solid state drive 120 and a random access memory 130, each of which is analogous to the like-numbered hardware components of computer system 100 shown in FIG. 1, as well as a network interface (not depicted) for communicating with the document server 210.

In one embodiment, each one the electronic devices 232, 234, 236 runs a browser application that accesses a client code either locally and/or from the document server 210. The client code, when running on the electronic device 232, 234, 236, allows accessing the document server 210 to receive a document and/or a synchronization document, reconstitute and/or open the document locally and display the document in a web browser window. In some embodiments, one of the electronic device 232, 234, 236 has a previous version of the document already stored in a memory (e.g., in the solid state drive 120 and/or in the random access memory 130) in which case the client code running on the one of the electronic device 232, 234, 236 may request the synchronisation document (and not the document in its entirety) to reconstitute the latest version of the document. In some alternative embodiments, if the client code determines that no previous version of the document is available in the memory, the client code may request the document (and not the synchronisation document). In some alternative embodiments, the client code may also be configured to receive user inputs specifying edits to the document originating from one or more of the electronic devices 232, 234, 236. The client code may also be configured to communicate edits to a document server code running on the document server 210 and modify the document and/or the synchronization document according to the edits.

In one embodiment, a communication channel (not depicted) between the electronic devices 232, 234, 236 and the document server 210 may be established to allow data exchange. Such data exchange may occur on a continuous basis or, alternatively, upon occurrence of certain events. For example, a data exchange may occur as a result of a user of one of the electronic devices 232, 234, 236 requesting opening of a document and receiving, in return, data associated with the document and/or the synchronization document. As another example, a data exchange may occur when the user of the one of the electronic devices 232, 234, 236 edits the document and data reflecting edits is transmitted to the document server 210 that may, in turn, transmit the data reflecting the edits to other ones of the electronic devices 232, 234, 236. Other variations of data exchange between the electronic devices 232, 234, 236 are also possible and will become apparent to a person skilled in the art of the present technology.

Once received by one of the electronic devices 232, 234, 236, the data relating to the document and/or the synchronization document may be stored in the memory of the one of the electronic devices 232, 234, 236 for immediate or later processing, for example by the processor 110 of the one of the electronic devices 232, 234, 236. Instructions to carry out the processing of the data may be implemented through the client code which may comprise a software module controlled by a visualisation interface. Alternatively, the software module may be controlled independently from the visualisation interface (e.g., may be controlled by an operating system of the one of the electronic devices 232, 234, 236). In other embodiments of the present technology, the instructions to carry out the processing may be implemented through a dedicated module (software and/or hardware) or a non-dedicated module (software and/or hardware) without departing from the scope of the present technology.

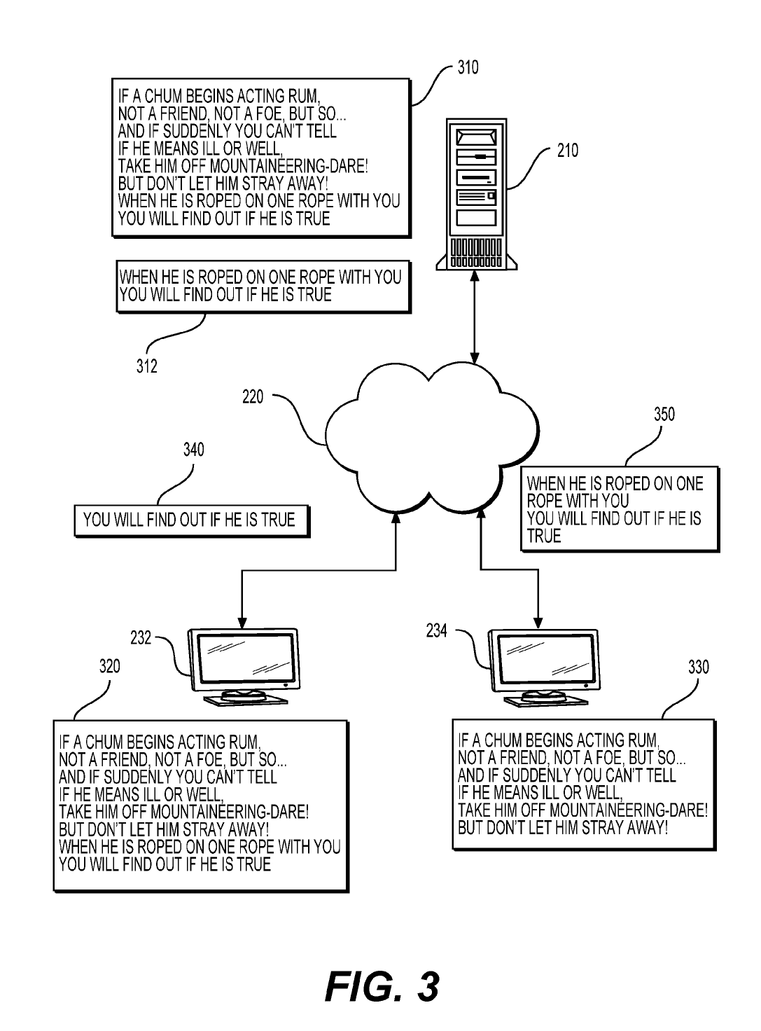

As it will be described with more details in the paragraphs below, the processing of data related to the document and/or the synchronization document aims at presenting the latest version of the document to the user associated with the ones of the electronic devices 232, 234, 236. Further details as to how the data is processed will be described in connection with FIG. 3 to FIG. 6.

How the software module and the visualisation interface are implemented is not particularly limited. One example of the software module and the visualisation interface may be embodied in a user accessing a web site associated with the document server 210 though a web browser client running on the electronic devices 232, 234, 236. For example, the visualisation interface may be accessed by typing in an URL associated with the web service Yandex.Disk available at https://disk.yandex.com. In another example, the visualisation interface may be embodied in a software application (also referred to as an “application” or an “app”) to be installed on the electronic devices 232, 234, 236. For example, the application implementing the visualisation interface may be downloaded by typing in an URL associated with an application store from which the application may be downloaded, such as, for example, the app Yandex.Disk available for downloading from the Yandex.Store from Yandex corporation of Lev Tolstoy st. 16, Moscow, 119021, Russia or from the Apple's App Store from Apple Inc. corporation of 1 Infinite Loop, Cupertino, Calif. 95014, United States of America. It should be expressly understood that the visualization interface may be accessed using any other commercially available or proprietary web service.

The electronic devices 232, 234, 236 are coupled to the network 220 via a communication link (not numbered). In some non-limiting embodiments of the present technology, the network can be implemented as the Internet. In other embodiments of the present technology, the network 220 can be implemented differently, such as any wide-area communications network, local-area communications network, a private communications network and the like.

How the communication link is implemented is not particularly limited and will depend on how the electronic devices 232, 234, 236 are implemented. Merely as an example and not as a limitation, in those embodiments of the present technology where the electronic devices 232, 234, 236 are implemented as a wireless communication device (such as a smart-phone), the communication link can be implemented as a wireless communication link (such as but not limited to, a 3G communications network link, a 4G communications network link, a Wireless Fidelity, or WiFi®, Bluetooth® and the like). In those examples, where the electronic devices 232, 234, 236 are implemented as a notebook computer, the communication link can be either wireless (such as the Wireless Fidelity, or WiFi®, Bluetooth® and the like) or wired (such as an Ethernet based connection).

It should be expressly understood that implementations for the electronic devices 232, 234, 236, the communication link and the network 220 are provided for illustration purposes only. As such, those skilled in the art will easily appreciate other specific implementational details for the electronic devices 232, 234, 236, the communication link and the network 220. As such, by no means, examples provided herein above are meant to limit the scope of the present technology.

Also coupled to the network 220 is the document server 210 on which a web service for processing and storing a document and a synchronization document is hosted. The document server 210 can be implemented as a conventional computer server. In an example of an embodiment of the present technology, the document server 210 can be implemented as a Dell™ PowerEdge™ Server running the Microsoft™ Windows Server™ operating system. Needless to say, the document server 210 can be implemented in any other suitable hardware and/or software and/or firmware or a combination thereof. In the depicted non-limiting embodiment of present technology, the document server 210 is a single server. In alternative non-limiting embodiments of the present technology, the functionality of the server 210 may be distributed and may be implemented via multiple servers.

The implementation of the document server 210 is well known to the person skilled in the art of the present technology. However, briefly speaking, the document server 210 comprises a communication interface (not depicted) structured and configured to communicate with various entities (such as the electronic devices 232, 234, 236 for example and other devices potentially coupled to the network 220) via the network 220. The document server 210 further comprises at least one computer processor (not depicted) operationally connected with the communication interface and structured and configured to execute various processes to be described herein.

The general purpose of the document server 210 is to process a document in a distributed architecture such as the one depicted at FIG. 2. What follows is a description of one non-limiting embodiment of the implementation for the computing server 210. However, it should be understood that there is a number of alternative non-limiting implementations of the document server 210 possible. It should be also expressly understood that in order to simplify the description presented herein below, the configuration of the document server 210 has been greatly simplified. It is believed that those skilled in the art will be able to appreciate implementational details for the document server 210 and for components thereof that may have been omitted for the purposes of simplification of the description.

The document server 210 may be communicatively coupled (or otherwise has access) to a frontend server implementing a mechanism (not shown) allowing transmitting the client code and/or the document and/or the synchronisation document to the electronic devices 232, 234, 236. In some embodiments, the frontend server may be configured to manage successive versions of the document. The frontend server may also be configured to receive an edit from a client code running on one of the electronic devices 232, 234, 236. The frontend server may also be configured to determine a suitable update for the several client codes running on the electronic devices 232, 234, 236 and transmit such suitable update to the electronic devices 232, 234, 236. Further details as to how the document server 210 and the electronic devices 232, 234, 236 interact together will be described in connection with FIG. 3 to FIG. 6.

The document server 210 may further be communicatively coupled (or otherwise has access) to a document database 212 and/or a synchronization database 214. As such, the document server 210 can be sometimes referred to as a “document server”, a “synchronization document server”, or a “data server”. Even though the document server 210 is depicted as a single unit, in some embodiments, the functionality of the document server 210 may be distributed and may be implemented via multiple servers without departing from the scope of the present technology. In some embodiments, the document database 212 and/or the synchronization database 214 may be hosted on the document server 210. In some embodiments, a first server hosted on the document server 210 may manage access to the document database 212 and a second server hosted on the document server 210 may manage access to the synchronization document database 214. In some embodiments, the first server and the second server defines a same server managing access to both the document database 212 and the synchronization database 214. In yet some embodiments, the first server and the second server are embedded in the functionality of a single server (such as, for example, the frontend server) hosted on the document server 210. In some other embodiments, the first server and the second server may each be hosted on a dedicated server. Multiple variations are possible and may be envisioned by a person skilled in the art without departing from the scope of the present technology.

In some embodiments, the document database 212 may store one or more documents created by one of the users. The one or more documents may include, for example but without being limitative, text documents, spreadsheet documents, presentation documents, image documents. In some embodiments, the one or more documents may include multimedia documents such audio and/or video documents. The one or more documents may be associated with multiple formats such as “.doc” or “.docx” compatible with Microsoft Word™, “.xls” or “.xlsx” compatible with Microsoft Excel™, “.ppt” or “.pptx” compatible with Microsoft PowerPoint™. As a person skilled in the art of the present technology may appreciate, multiple document types and/or document formats may be envisioned without departing from the scope of the present technology. In some embodiments, the document database 212 aims at storing an entirety of a document in a relative permanent manner. As a result, in some embodiments, a memory hosting the document database 212 may be selected based on its ability to ensure long-term storage of the document at the expense of a speed of access. In some embodiments, the memory may be a solid-state drive similar to the solid-state drive 120 depicted at FIG. 1. Even though reference is made to the document database “212”, the term “database” should not be construed as being limitative. To the contrary, the term “database” should be construed as encompassing, but without being limitative, any repository and/or storage wherein a document may be stored, independently of a specific data structure. Other variations may also become apparent to the person skilled in the art of the present technology without departing from the scope of the present technology.

The one or more documents stored at the document database 212 may take multiple forms. In some embodiments, the one or more documents may comprise a content portion and a set of revision records. In some embodiments, the content portion may comprise a set of revision records. Under such embodiments, the one or more documents may have a log-like structure, each entry of the log-like structure being reflective of an edit made by one or more users and allowing reconstituting a most recent version of the document. In some other embodiments, the content portion may comprise a version of a document at a given time without including revision records allowing reconstituting prior versions of the document prior to the given time. In some embodiments, the set of revision records may comprise a rolling subset of past revisions and/or past edits allowing reconstituting at least some previous versions of the documents once the rolling subset is combined with the content portion of the document. As a person skilled in the art of the present technology may appreciate, multiple variations may be envisioned without departing from the scope of the present technology.

In some embodiments, the synchronization document database 214 may store one or more synchronization documents resulting from the creation of a document and/or edits made to a previously existing document by one or more users. The one or more synchronization documents may include a subset of the document to which it relates. In some embodiments, the synchronization document database 214 aims at storing a subset of revisions records of a document. In some embodiments, the subset of revision records may be a portion of the document. In some other embodiments, the subset of revision records may be a series of entries allowing reconstituting a version of the document when combined with a previous version of the document. As a person skilled in the art of the present technology may appreciate, the subset of revision records may allow reconstituting a most recent version of a document on an electronic device which has access, in its local memory, to a previous version of the document without requiring the document server 210 to transmit the most recent version of the document in its entirety to the electronic device. In such embodiments, transmitting the subset of revision records may be sufficient. As a result, in some embodiments, a memory hosting the synchronization document database 214 may be selected based on its ability to ensure fast access and therefore fast transmission from the document server 210 to one or more of the electronic devices 232, 234, 236 without necessitating long-term storage capacity. In some embodiments, the memory may be a random access memory similar to the random access memory 130 depicted at FIG. 1. Even though reference is made to the synchronization document database “214”, the term “database” should not be construed as being limitative. To the contrary, the term “database” should be construed as encompassing, but without being limitative, any repository and/or storage wherein a synchronization document may be stored, independently of a specific data structure. Other variations may also become apparent to the person skilled in the art of the present technology without departing from the scope of the present technology.

The one or more synchronization documents stored at the synchronization document database 214 may take multiple forms. In some embodiments, the one or more synchronization documents may comprise a set of revision records reflective of previous edits made by one or more users. Under such embodiments, the one or more documents may have a log-like structure, each entry of the log-like structure being reflective of an edit made by one or more users and allowing reconstituting a most recent version of the document.

In some embodiments, the set of revision records may comprise a rolling subset of revisions and/or edits allowing reconstituting at least some previous versions of the documents once the rolling subset is combined with a previous version of the document. In some embodiments, such rolling subset may have a predetermined size, which may determined based on a number of entries and/or a number of logs and/or a memory unit size (e.g., a predetermined number of octets). In such embodiments, the set of revisions may only include a predetermined number of entries stored according to a “first in first out” (FIFO) model thereby comprising a predetermined number of the most recent edits made to a document. In other words, the set of revisions may comprise the last n changes to the document wherein n may be a number of entries in a log file (e.g., a number of lines, a number of characters, a number of memory units). Under such embodiment, if an electronic device receives the set of revisions and is able to reconstitute the most recent version of the document by combining the set of revisions with a previous version of the document stored in its memory, then the only transmission to occur between the document server 210 and the electronic device is the sending of the set of revisions. For instances wherein the set of revisions may not allow the electronic device to reconstitute the most recent version of the document (e.g., the number of edits made since the last version stored on the electronic device exceeds the number of edits that may be stored on the synchronization document), then the entire document may be accessed from the document database 212 and transmitted from the document server 210 to the electronic device. The determination as to whether the document and/or the synchronization document is to be sent to one or more of the electronic device 232, 234, 236 may be established by the document server 210, the one or more of the electronic device 232, 234, 236 or a combination of both. As a person skilled in the art of the present technology may appreciate, multiple variations may be envisioned without departing from the scope of the present technology.

Turning to FIG. 3, a diagram illustrating a document along with a synchronisation document in accordance with an embodiment of the present technology is depicted. The depicted document relates to a text document created by a user associated with the electronic device 232. A document 320 is created by the user associated with the electronic device 232 by accessing the document server 210 and requesting the creation of a new shared document. As a result of the request initiated by the electronic device 232, the document server 210 creates a document 310. The document 310 may be stored in the document database 212. In parallel to the creation of the document 310, the document 320 is created in a memory of the electronic device 232. The document 320 is being edited by the user associated with the electronic device 232 and edits are transmitted by the electronic device 232 to the document server 210. The document server 210 updates the document 310 accordingly while monitoring a size of the document 310. Upon determining that the document 310 exceeds a certain size, then the document server 210 creates a synchronization document 312. The synchronization document 312 may be stored in the synchronization database 214. In the example depicted at FIG. 3, the synchronization document 312 is defined so as to be a rolling subset of revision records including the two most recent lines of the document. As a result, in the example depicted at FIG. 3, the synchronization document 312 comprises the two last lines of the document 310.

Also depicted in FIG. 3 is an edit 340 comprising one line of text and transmitted from the electronic device 232 to the document server 210. Once received by the document server 210, the edit 340 is processed to update the document 310 and the synchronization document 312. The document server 310 may receive a synchronization request from the electronic device 234 associated with the same user or a different user than the user associated with the electronic device 232. The electronic device 234, at the time it sent the synchronization request to the document server 210 had a previous version of the document 330 stored in its memory corresponding to a previous version of the document 310. Upon receiving the synchronization request from the electronic device 234, the document server 210 may access the synchronization database 214 to retrieve the synchronization document 312 and transmit the synchronization document 312 to the electronic device 234 via a data package 350 comprising the synchronization document 312. Once received by the electronic device 234, the electronic device 234 may combine the synchronization document 312 and the previous version of the document 330 to generate the most recent version of the document corresponding to the document 310. In some embodiments, providing that the synchronization document 312 would not allow to generate the most recent version of the document, the document server 210 and/or the electronic device 234 may trigger the sending of the document 310 (i.e., the entire document).

As a person skilled in the art of the present technology may appreciate, the approach exemplified in FIG. 3 may (i) reduce an amount of data to be transmitted between the document server 210 and the electronic device 234 upon synchronizing the document server 210 and the electronic device 234; and (ii) improve a user experience by reducing an amount of time required for the electronic device 234 to present the document to the user associated with the electronic device 234. For situations wherein a synchronization document does not allow to generate the most recent version of a document, the present technology may also provide a mechanism allowing the document server 210 to transmit the entire document so as to ensure that the electronic device 234 may be able to provide the most recent version of the document to the user associated with the electronic device 234. As the person skilled in the art of the present technology will appreciate, the example of FIG. 3 should not be construed as being limitative and multiple variations may become apparent without departing from the scope of the present technology.

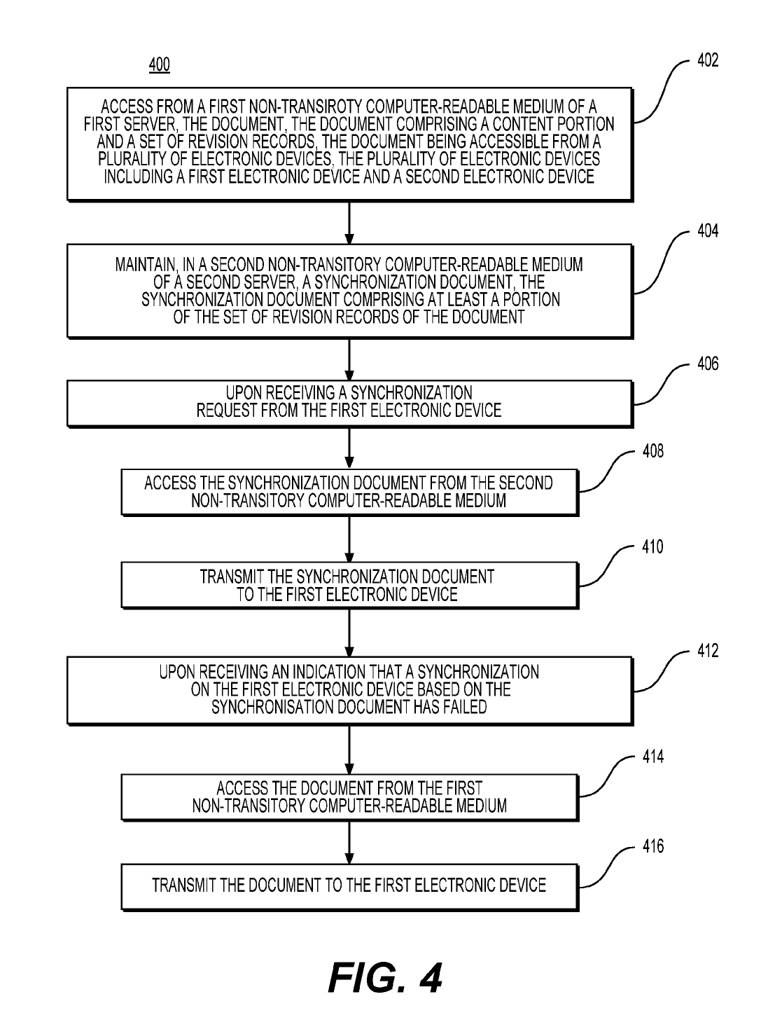

Having described, with reference to FIG. 1 to FIG. 3, some non-limiting example instances of systems and computer-implemented methods used in connection with the problem of processing a document in a distributed architecture, we shall now describe a general solution to this problem with references to FIG. 4 to FIG. 6.

More specifically, FIG. 4 shows a flowchart illustrating a first computer-implemented method 400 implementing embodiments of the present technology. The computer-implemented method of FIG. 4 may comprise a computer-implemented method executable by a processor of the document server 210 and/or a processor of one or more of the electronic devices 232, 234, 236, the method comprising a series of steps to be carried out by the document server 210 and/or one or more of the electronic devices 232, 234, 236.

The computer-implemented method of FIG. 4 may be carried out, for example, in the context of the document server 210 by the processor 110 executing program instructions having been loaded into random access memories 130 from solid-state drives 120 of the document server 210.

The method 400 starts at a step 402 by executing accessing, from a first non-transitory computer-readable medium of a first server, the document, the document comprising a content portion and a set of revision records, the document being accessible from a plurality of electronic devices, the plurality of electronic devices including a first electronic device and a second electronic device.

In some embodiments, the content portion is a first set of revision records and the set of revision records is a second set of revision records. In yet some embodiments, the first set of revision records and the second set of revision records are indicative of at least one of characters to be added and characters to be removed as a result of an interaction of a user with one of the first electronic device and the second electronic device. In yet some embodiments, the content portion and the set of revision records have a log-like structure.

The method 400 pursues with step 404 by executing maintaining, in a second non-transitory computer-readable medium of a second server, a synchronization document, the synchronization document comprising at least a portion of the set of revision records of the document. In some embodiments, the synchronization document comprises a rolling subset of past edits made to the document. In yet some embodiments, upon determining that the document exceeds a threshold, the method 400 may create in the second non-transitory computer-readable medium of the second server, the synchronization document based on at least one of the content portion and the set of revision records of the document. In some embodiments, determining that the document exceeds a threshold comprises at least one of determining that the document exceeds a predetermined number of log entries and determining that the document exceeds a predetermined size expressed in memory unit.

In some embodiments, the first non-transitory computer-readable medium of the first server is a long-term non-transitory computer-readable medium for long-term storage. In yet some embodiments, the second non-transitory computer-readable medium of the second server is a short-term non-transitory computer-readable medium for short-term storage having a faster memory access speed than a memory access speed of the first non-transitory computer-readable medium of the first server.

The method 400 may pursue with step 406 by executing, upon receiving a synchronization request from the first electronic device, steps 408 and 410. At step 408, the method 400 may access synchronization document from the second non-transitory computer-readable medium. At step 410, the method 400 may transmit the synchronization document to the first electronic device.

The method 400 may also include step 412 by executing, upon receiving an indication that a synchronization on the first electronic device based on the synchronisation document has failed, steps 414 and 416. At step 414, the method 400 may access the document from the first non-transitory computer-readable medium. At step 416, the method 400 may transmit the document to the first electronic device.

In some embodiments, the method 400 may further comprise upon receiving a first new revision record from the first electronic device: (i) adding the first new revision record to the document stored in the first non-transitory computer-readable medium; and (ii) adding the first new revision record to the synchronization document stored in the second non-transitory computer-readable medium.

The method 400 may also further comprise upon receiving a first new revision record associated with a first version of the document from the first electronic device and a second new revision record associated with the first version of the document from the second electronic device: (i) accessing at least one of the document from the first non-transitory computer-readable medium and the synchronization document from the second non-transitory computer-readable medium; and (ii) generating a new merged revision record based on at least one of the first new revision record, the second new revision record, the document and the synchronization document.

The method 400 may also further comprise (i) adding the new merged revision record to the document stored in the first non-transitory computer-readable medium; and (ii) adding the new merged revision record to the synchronization document stored in the second non-transitory computer-readable medium.

In some embodiments, the indication that the synchronization has failed is further to determining, by the first electronic device, that the synchronization document does not allow proper synchronization between a local content stored in a non-transitory computer-readable medium of the first electronic device and the synchronization document.

In some embodiments, determining, by the first electronic device, that the synchronization document does not allow proper synchronization comprises determining that the synchronization document does not contain at least some data required for creating a local version of the document stored in the non-transitory computer-readable medium of the first electronic device, the local version of the document being a mirror image of the document stored in the first non-transitory computer-readable medium of the first server.

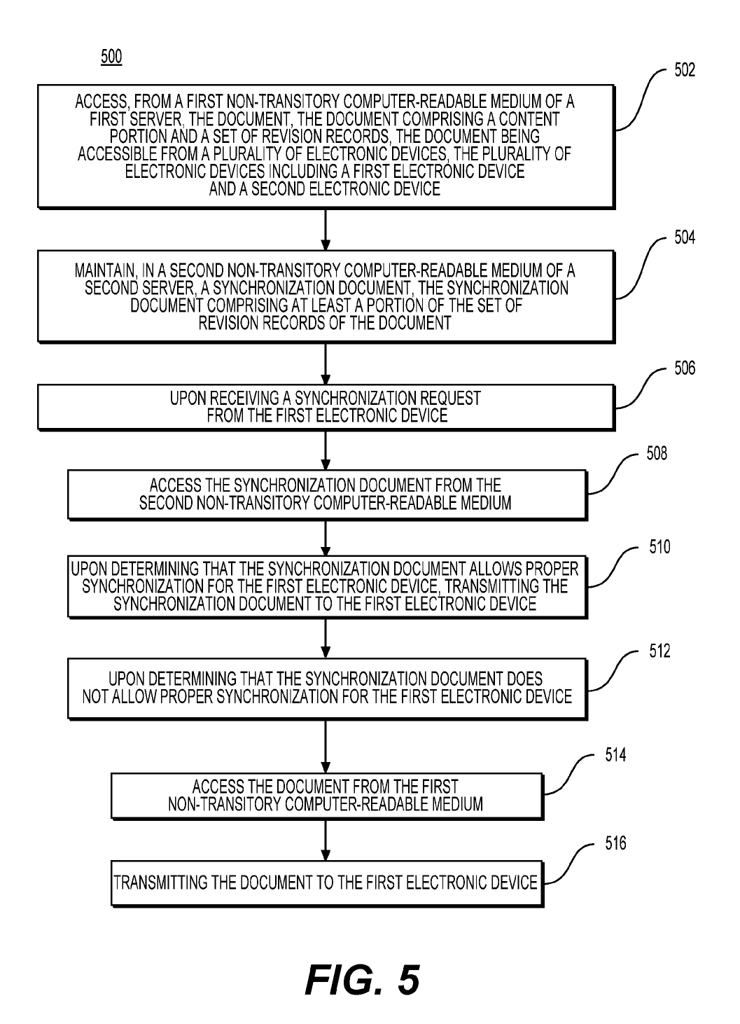

Turning now to FIG. 5, a flowchart illustrating a second computer-implemented method 500 implementing embodiments of the present technology is shown. The computer-implemented method of FIG. 5 may comprise a computer-implemented method executable by a processor of the document server 210 and/or a processor of one or more of the electronic devices 232, 234, 236, the method comprising a series of steps to be carried out by the document server 210 and/or one or more of the electronic devices 232. As it may become apparent to the person skilled in the art of the present technology, the series of steps defining the method 500 may be combined with at least some of the steps of the method 400 without departing from the scope of the present technology.

The computer-implemented method of FIG. 5 may be carried out, for example, in the context of the document server 210 by the processor 110 executing program instructions having been loaded into random access memories 130 from solid-state drives 120 of the document server 210.

The method 500 starts at a step 502 by executing accessing, from a first non-transitory computer-readable medium of a first server, the document, the document comprising a content portion and a set of revision records, the document being accessible from a plurality of electronic devices, the plurality of electronic devices including a first electronic device and a second electronic device. The method may then proceed to step 504 by executing maintaining, in a second non-transitory computer-readable medium of a second server, a synchronization document, the synchronization document comprising at least a portion of the set of revision records of the document.

At a step 506, the method 500 may execute, upon receiving a synchronization request from the first electronic device, steps 508, 510 and 512. The step 508 may comprise accessing the synchronization document from the second non-transitory computer-readable medium. The step 510 may comprise upon determining that the synchronization document allows proper synchronization for the first electronic device, transmitting the synchronization document to the first electronic device. The step 512 may execute, upon determining that the synchronization document does not allow proper synchronization for the first electronic device, steps 514 and 516. The step 514 may comprise accessing the document from the first non-transitory computer-readable medium. The step 516 may comprise transmitting the document to the first electronic device.

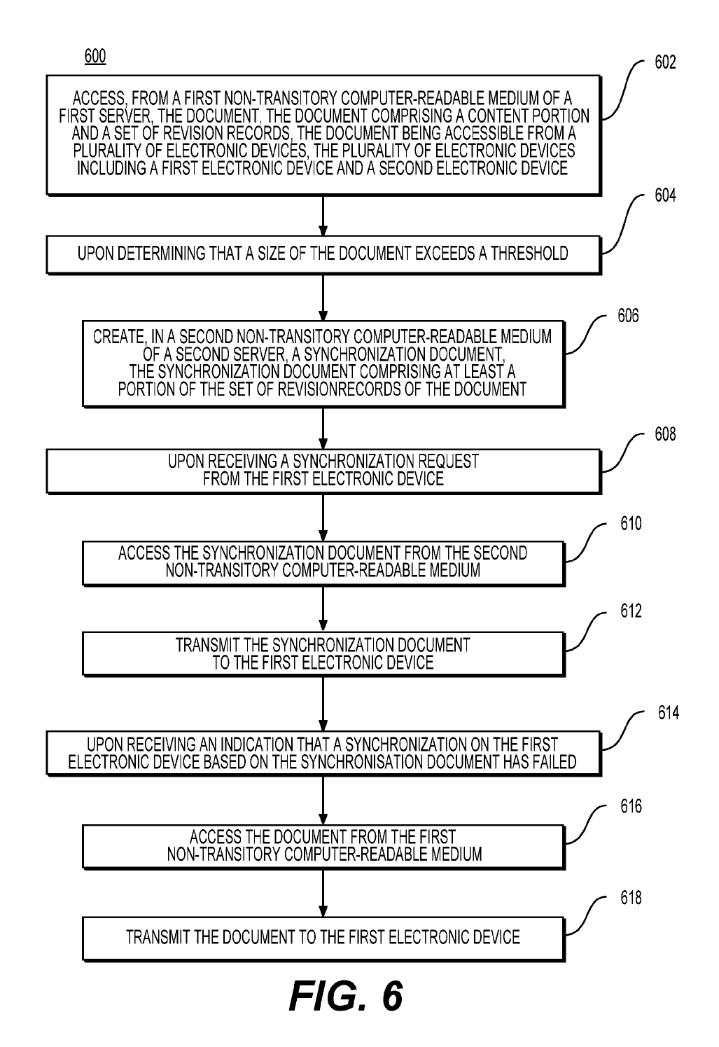

Turning now to FIG. 6, a flowchart illustrating a third computer-implemented method 600 implementing embodiments of the present technology is shown. The computer-implemented method of FIG. 6 may comprise a computer-implemented method executable by a processor of the document server 210 and/or a processor of one or more of the electronic devices 232, 234, 236, the method comprising a series of steps to be carried out by the document server 210 and/or one or more of the electronic devices 232. As it may become apparent to the person skilled in the art of the present technology, the series of steps defining the method 600 may be combined with at least some of the steps of the method 400 and/or the method 500 without departing from the scope of the present technology.

The computer-implemented method of FIG. 6 may be carried out, for example, in the context of the document server 210 by the processor 110 executing program instructions having been loaded into random access memories 130 from solid-state drives 120 of the document server 210.

The method 600 starts at a step 602 by executing accessing, from a first non-transitory computer-readable medium of a first server, the document, the document comprising a content portion and a set of revision records, the document being accessible from a plurality of electronic devices, the plurality of electronic devices including a first electronic device and a second electronic device. At a step 604, upon determining that a size of the document exceeds a threshold, the method 600 may execute a step 606. The step 606 comprises creating, in a second non-transitory computer-readable medium of a second server, a synchronization document, the synchronization document comprising at least a portion of the set of revision records of the document.

Then, at a step 608, the method 600 may comprise, upon receiving a synchronization request from the first electronic device, executing steps 610 and 612. The step 610 may comprise accessing the synchronization document from the second non-transitory computer-readable medium. The step 612 may comprise transmitting the synchronization document to the first electronic device.

At a step 614, the method 600 may comprise, upon receiving an indication that a synchronization on the first electronic device based on the synchronisation document has failed, executing steps 616 and 618. The step 616 may comprise accessing the document from the first non-transitory computer-readable medium. The step 618 may comprise transmitting the document to the first electronic device.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

As such, the methods and systems implemented in accordance with some non-limiting embodiments of the present technology can be represented as follows, presented in numbered clauses.

[Clause 1] A computer-implemented method (400) of processing a document in a distributed architecture (200), the method, for execution by a processor (110), comprising:
accessing, from a first non-transitory computer-readable medium of a first server, the document (310), the document (310) comprising a content portion and a set of revision records, the document (310) being accessible from a plurality of electronic devices, the plurality of electronic devices including a first electronic device (232) and a second electronic device (234);
maintaining, in a second non-transitory computer-readable medium of a second server, a synchronization document (312), the synchronization document comprising at least a portion of the set of revision records of the document;
upon receiving a synchronization request from the first electronic device (232):
   (i) accessing the synchronization document (312) from the second non-transitory computer-readable medium;
   (ii) transmitting the synchronization document (312) to the first electronic device (232);
upon receiving an indication that a synchronization on the first electronic device (232) based on the synchronisation document (312) has failed:
   (i) accessing the document (310) from the first non-transitory computer-readable medium; and
   (ii) transmitting the document (310) to the first electronic device (232).

[Clause 2] The method of clause 1, further comprising, upon receiving a first new revision record from the first electronic device (232):
(i) adding the first new revision record (340) to the document (310) stored in the first non-transitory computer-readable medium; and
(ii) adding the first new revision record (340) to the synchronization document (312) stored in the second non-transitory computer-readable medium.

[Clause 3] The method of any one of clauses 1 and 2, further comprising, upon receiving a first new revision record (340) associated with a first version of the document from the first electronic device (232) and a second new revision record associated with the first version of the document from the second electronic device (234):
(i) accessing at least one of the document (310) from the first non-transitory computer-readable medium and the synchronization document (312) from the second non-transitory computer-readable medium; and
(ii) generating a new merged revision record based on at least one of the first new revision record, the second new revision record, the document (310) and the synchronization document (312).

[Clause 4] The method of clause 3, further comprising:
(i) adding the new merged revision record to the document (310) stored in the first non-transitory computer-readable medium; and
(ii) adding the new merged revision record to the synchronization document (312) stored in the second non-transitory computer-readable medium.

[Clause 5] The method of clause 1, wherein the content portion is a first set of revision records and the set of revision records is a second set of revision records.

[Clause 6] The method of clause 5, wherein the first set of revision records and the second set of revision records are indicative of at least one of characters to be added and characters to be removed as a result of an interaction of a user with one of the first electronic device and the second electronic device.

[Clause 7] The method of clause 1, wherein at least one of the content portion and the set of revision records have a log-like structure.

[Clause 8] The method of clause 7, wherein maintaining, in the second non-transitory computer-readable medium of the second server, the synchronization document (312) comprises, upon determining that the document exceeds a threshold, creating in the second non-transitory computer-readable medium of the second server, the synchronization document (312) based on at least one of the content portion and the set of revision records of the document.

[Clause 9] The method of clause 8, wherein determining that the document (310) exceeds a threshold comprises at least one of determining that the document exceeds a predetermined number of log entries and determining that the document exceeds a predetermined size expressed in memory unit.

[Clause 10] The method of clause 1, wherein the indication that the synchronization has failed is further to determining, by the first electronic device, that the synchronization document (312) does not allow proper synchronization between a local content stored in a non-transitory computer-readable medium of the first electronic device (232) and the synchronization document (312).

[Clause 11] The method of clause 10, wherein determining, by the first electronic device (232), that the synchronization document (312) does not allow proper synchronization comprises determining that the synchronization document (312) does not contain at least some data required for creating a local version of the document stored in the non-transitory computer-readable medium of the first electronic device (232), the local version of the document being a mirror image of the document stored in the first non-transitory computer-readable medium of the first server.

[Clause 12] The method of any one of clauses 1 to 11, wherein the first non-transitory computer-readable medium of the first server is a long-term non-transitory computer-readable medium for long-term storage.

[Clause 13] The method of any one of clauses 1 to 12, wherein the second non-transitory computer-readable medium of the second server is a short-term non-transitory computer-readable medium for short-term storage having a faster memory access speed than a memory access speed of the first non-transitory computer-readable medium of the first server.

[Clause 14] The method of any one of clauses 1 to 13, wherein the synchronization document (312) comprises a rolling subset of past edits made to the document.

[Clause 15] A computer-implemented method (500) of processing a document in a distributed architecture (200), the method, for execution by a processor (110), comprising:
accessing, from a first non-transitory computer-readable medium of a first server, the document (310), the document (310) comprising a content portion and a set of revision records, the document (310) being accessible from a plurality of electronic devices, the plurality of electronic devices including a first electronic device (232) and a second electronic device (234);
maintaining, in a second non-transitory computer-readable medium of a second server, a synchronization document (312), the synchronization document comprising at least a portion of the set of revision records of the document;
upon receiving a synchronization request from the first electronic device (232):
(i) accessing the synchronization document (312) from the second non-transitory computer-readable medium;
(ii) upon determining that the synchronization document (312) allows proper synchronization for the first electronic device (232), transmitting the synchronization document (312) to the first electronic device (232);
(iii) upon determining that the synchronization document (312) does not allow proper synchronization for the first electronic device (232):
   (a) accessing the document (310) from the first non-transitory computer-readable medium; and
   (b) transmitting the document (310) to the first electronic device (232).

[Clause 16] A computer-implemented method (600) of processing a document (310) in a distributed architecture (200), the method, for execution by a processor (110), comprising:
accessing, from a first non-transitory computer-readable medium of a first server, the document (310), the document (310) comprising a content portion and a set of revision records, the document (310) being accessible from a plurality of electronic devices, the plurality of electronic devices including a first electronic device (232) and a second electronic device (234);
upon determining that a size of the document (310) exceeds a threshold:
   (i) creating, in a second non-transitory computer-readable medium of a second server, a synchronization document (312), the synchronization document (312) comprising at least a portion of the set of revision records of the document;
   upon receiving a synchronization request from the first electronic device (232):
      (i) accessing the synchronization document (312) from the second non-transitory computer-readable medium;
      (ii) transmitting the synchronization document (312) to the first electronic device (232);
   upon receiving an indication that a synchronization on the first electronic device (232) based on the synchronisation document (312) has failed:
      (i) accessing the document (310) from the first non-transitory computer-readable medium; and
      (ii) transmitting the document (310) to the first electronic device (232).

[Clause 17] A computer-implemented system configured to perform the method of any one of clauses 1 to 16.

[Clause 18] A non-transitory computer-readable medium comprising computer-executable instructions that cause a system to execute the method according to any one of clauses 1 to 17.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method of processing a document in a distributed architecture, the method, for execution by a processor, comprising:
accessing, from a first non-transitory computer-readable medium of a first server, the document, the document comprising a content portion and a set of revision records, the document being accessible from a plurality of electronic devices, the plurality of electronic devices including a first electronic device and a second electronic device;
determining that the document exceeds a threshold;
in response to determining that the document exceeds the threshold, generating, in a second non-transitory computer-readable medium of a second server, a synchronization document, the synchronization document comprising at least a portion of the set of revision records of the document;
upon receiving a synchronization request from the first electronic device for a most recent version of the document:
(i) accessing the synchronization document from the second non-transitory computer-readable medium;
(ii) transmitting the synchronization document to the first electronic device;
upon receiving an indication that a synchronization of the document on the first electronic device based on the synchronization document has failed, such that the electronic device was unable to reconstitute the most recent version of the document based on the at least a portion of the set of revision records of the synchronization document:
(i) accessing the most recent version of the document from the first non-transitory computer-readable medium; and
(ii) transmitting the most recent version of the document to the first electronic device.

2. The method of claim 1, further comprising, upon receiving a first new revision record from the first electronic device:
(i) adding the first new revision record to the document stored in the first non-transitory computer-readable medium; and
(ii) adding the first new revision record to the synchronization document stored in the second non-transitory computer-readable medium.

3. The method of claim 1, further comprising, upon receiving a first new revision record associated with a first version of the document from the first electronic device and a second new revision record associated with the first version of the document from the second electronic device:
(i) accessing at least one of the document from the first non-transitory computer-readable medium and the synchronization document from the second non-transitory computer-readable medium; and
(ii) generating a new merged revision record based on at least one of the first new revision record, the second new revision record, the document and the synchronization document.

4. The method of claim 3, further comprising:
(i) adding the new merged revision record to the document stored in the first non-transitory computer-readable medium; and
(ii) adding the new merged revision record to the synchronization document stored in the second non-transitory computer-readable medium.

5. The method of claim 1, wherein the content portion is a first set of revision records and the set of revision records is a second set of revision records.

6. The method of claim 5, wherein the first set of revision records and the second set of revision records are indicative of at least one of characters to be added and characters to be removed as a result of an interaction of a user with one of the first electronic device and the second electronic device.

7. The method of claim 1, wherein at least one of the content portion and the set of revision records have a log-like structure.

8. The method of claim 7, wherein the generating, in the second non-transitory computer-readable medium of the second server, the synchronization document is based on at least one of the content portion and the set of revision records of the document.

9. The method of claim 8, wherein determining that the document exceeds a threshold comprises at least one of determining that the document exceeds a predetermined number of log entries and determining that the document exceeds a predetermined size expressed in memory unit.

10. The method of claim 1, wherein the indication that the synchronization has failed is further to determining, by the first electronic device, that the synchronization document does not allow proper synchronization between a local content stored in a non-transitory computer-readable medium of the first electronic device and the synchronization document.

11. The method of claim 10, wherein determining, by the first electronic device, that the synchronization document does not allow proper synchronization comprises determining that the synchronization document does not contain at least some data required for creating a local version of the most recent version of the document stored in the non-transitory computer-readable medium of the first electronic device, the local version of the document being a mirror image of the most recent version of the document stored in the first non-transitory computer-readable medium of the first server.

12. The method of claim 1, wherein the first non-transitory computer-readable medium of the first server is a long-term non-transitory computer-readable medium for long-term storage.

13. The method of claim 1, wherein the second non-transitory computer-readable medium of the second server is a short-term non-transitory computer-readable medium for short-term storage having a faster memory access speed than a memory access speed of the first non-transitory computer-readable medium of the first server.

14. The method of claim 1, wherein the synchronization document comprises a rolling subset of past edits made to the document.

15.-16. (canceled)

17. A computer-implemented system for processing a document in a distributed architecture, the system comprising:
a non-transitory computer-readable medium;
a processor configured to perform:
accessing, from a first non-transitory computer-readable medium of a first server, the document, the document comprising a content portion and a set of revision records, the document being accessible from a plurality of electronic devices, the plurality of electronic devices including a first electronic device and a second electronic device;
determining that the document exceeds a threshold;
in response to determining that the document exceeds the threshold, generating, in a second non-transitory computer-readable medium of a second server, a synchronization document, the synchronization document comprising at least a portion of the set of revision records of the document;
upon receiving a synchronization request from the first electronic device for a most recent version of the document:
(i) accessing the synchronization document from the second non-transitory computer-readable medium;
(ii) transmitting the synchronization document to the first electronic device;
upon receiving an indication that a synchronization of the document on the first electronic device based on the synchronization document has failed, such that the electronic device was unable to reconstitute the most recent version of the document based on the at least a portion of the set of revision records of the synchronization document:
(i) accessing the most recent version of the document from the first non-transitory computer-readable medium; and
(ii) transmitting the most recent version of the document to the first electronic device.

18. The system of claim 17, wherein the processor is further configured to perform, upon receiving a first new revision record from the first electronic device:
(i) adding the first new revision record to the document stored in the first non-transitory computer-readable medium; and
(ii) adding the first new revision record to the synchronization document stored in the second non-transitory computer-readable medium.

19. The system of claim 17, wherein the processor is further configured to perform, upon receiving a first new revision record associated with a first version of the document from the first electronic device and a second new revision record associated with the first version of the document from the second electronic device:
(i) accessing at least one of the document from the first non-transitory computer-readable medium and the synchronization document from the second non-transitory computer-readable medium; and
(ii) generating a new merged revision record based on at least one of the first new revision record, the second new revision record, the document and the synchronization document.

20. The system of claim 19, wherein the processor is further configured to perform:
(i) adding the new merged revision record to the document stored in the first non-transitory computer-readable medium; and
(ii) adding the new merged revision record to the synchronization document stored in the second non-transitory computer-readable medium.

21. The system of claim 17, wherein the content portion is a first set of revision records and the set of revision records is a second set of revision records.

22. The system of claim 21, wherein the first set of revision records and the second set of revision records are indicative of at least one of characters to be added and characters to be removed as a result of an interaction of a user with one of the first electronic device and the second electronic device.

23.-32. (canceled)
